(19) United States
(12) Patent Application Publication
(10) Pub. No.: US 2016/0162040 A1
(43) Pub. Date: Jun. 9, 2016

(54) SYSTEM AND METHOD FOR OPERATING A COMPUTER PROGRAM WITH PHYSICAL OBJECTS

(71) Applicant: Zheng Shi, Beijing (CN)

(72) Inventor: Zheng Shi, Beijing (CN)

(21) Appl. No.: 15/044,120

(22) Filed: Feb. 16, 2016

Related U.S. Application Data
(63) Continuation-in-part of application No. PCT/CN2014/079891, filed on Jun. 13, 2014.

(51) Int. Cl. G06F 3/03; G06F 3/0354; A63F 13/55; G06F 3/16; G06F 3/00; G06F 3/041; G06F 3/0488; G06F 3/01

(52) U.S. Cl. CPC G06F 3/03; G06F 3/04883; G06F 3/03545; G06F 3/016; G06F 3/167; G06F 3/005; G06F 3/0414; A63F 13/55; G06F 2203/0337

(57) ABSTRACT

The present invention provides a system and method to enable a user to use physical objects to interact with a computer program. The system includes an interactive surface without a display screen; a computer system operatively linked to the interactive surface and configured to execute a plurality of computer programs; a plurality of physical objects, each comprising an identifier and marked with an element of a user interface of a computer program, and a physical sheet configured to substantially cover the interactive surface. Once the physical sheet is placed on or near the interactive surface, the computer system is configured to load up the computer program corresponding to the physical sheet. And once a physical object is placed on the physical sheet, the interactive surface is configured to recognize the identifier and location information of the physical object, the computer system is configured to execute the computer program corresponding to the physical sheet, and the computer program is configured to be operated through an interaction with the physical object.

### CROSS-REFERENCE TO RELATED APPLICATION

This application is a continuation in part of International Patent Application No. PCT/CN2014/079891, entitled “System and Method for Operating a Computer Program with Physical Objects” filed on Jun. 13, 2014. The entire disclosures of the above application are incorporated herein by reference.

### TECHNICAL FIELD

The present invention relates to the field of user interfaces and interactive input systems on interactive surfaces without display screens.

### BACKGROUND

Computer systems use a combination of screens and input devices such as keyboards and mice in order for a user to operate computer programs. The GUI (Graphical User Interface) that uses the WIMP (window, icon, menu and pointing device) principle was invented at the Xerox Park Lab in the 1970s. This was to become the template by which all commercial computer systems would adhere to. Indeed, all commercial systems developed by Apple, Microsoft and Sun Microsystems to this day use some form of GUI system in order to allow users to naturally interact with computer programs.

In fact, with the advent of the computer age, information is mostly conveyed through screens which have the obvious benefits of ease-of-use and capable of providing real-time feedback to users. This last point is particular true in video games applications. Nevertheless, the fact that people are increasingly exposed to a world where information is transmitted to them through screens can also have negative repercussions, especially to a most vulnerable demographic: young children.

Indeed, as parents are increasingly relying on computers and smart-phones as both educational and entertainment devices for their children, children are increasingly exposed to screens from an early age. This trend is seen as worrisome by many prominent child development experts who warn that this may have significantly adverse effects not only on children's eye sight, but also on their development.

Therefore, it is increasingly clear that although there are clear benefits associated with screen-based computer devices in both educating and entertaining children, there are also real health and development costs.

Currently, there exist a number of electronic books where markers, styluses or even fingers are used by the user to interact with the book so as to prompt feedback from a computer system—typically in the form of an audio recording. Nevertheless, these systems are still rudimentary and do not offer a wide-ranging level of interactivity between the system and the user. Furthermore, these systems rarely allow for the use of physical objects such as cards, toys, sheets and the like to be used in conjunction with the device, which is something young users would find natural and fun to use.

Accordingly, there is need to introduce a new and innovative device that negates the use of screens but retains the power of computer systems in order to allow for a greater level of interactivity between the user and the device.

Instead of using the common input devices in conjunction with a screen in traditional computer systems, the present invention provides a completely new user-computer system operating medium that eliminates the screen. The embodiments of the present invention use an interactive surface as the user's operating area, which is configured in such a way that it can accommodate physical objects as the means by which users input commands into a computer system. Feedback is provided to the user through any medium other than screens. Lighting (e.g., in the form of LED), vibration, self-propelled objects, and audio feedback are all viable options and can be used in connection with embodiments of the present invention.

Particularly, the embodiments of the present invention can be seen as a computerized board game and is designed to educate players and/or to entertain the players in the form of a game using a low-cost, but effective interactive board. The embodiments of the present invention retain the benefits of computer systems in conjunction with natural and physical communication mediums (not including screens). The concept underlying the present invention is potentially revolutionary, and its applications are countless.

### SUMMARY OF THE INVENTION

The embodiments of the present invention provide a system and method to enable a user to operate a computer program with physical objects. The system includes an interactive surface without a display screen having an array of sensors embedded on or under its surface that is operatively linked to a computer system. The system further includes a computer system operatively linked to the interactive surface and configured to execute a plurality of computer programs, and a physical sheet configured to substantially cover the interactive surface. Once the physical sheet is placed on or near the interactive surface, the computer system is configured to load up the computer program corresponding to the physical sheet. And then users can place physical objects on the physical sheet and thereafter operate the computer program through an interaction with the physical objects. The present invention is useful in developing educational and entertainment programs especially for young children.

The embodiments of the present invention provide a system and method to recognize the ID and position of one or more physical objects placed on the surface of an interactive board such as a game board or an interactive book. The system is composed of an interactive board (mainly comprising sensors and a computer system with both a CPU and memory units), and one or more objects (containing an identifier). The position and ID of objects placed on the board surface is detected by the interactive surface's sensors, which communicate such information to the interactive board's computer system for processing. The sensors in question can use any type of technologies, such as electromagnetic coupling between the object and the sensor, or RF communication between the board and the object. In the case of RF communication, both the board and the object need to contain an RF antenna, and the object may further contain a computer system of its own.

In accordance with one embodiment of the present invention, the identifier of the physical object comprises of a UID embedded in the physical object, and the interactive surface is configured to recognize the UID. And in accordance with another embodiment of the present invention, the UID comprises an RFID chip.

In accordance with one embodiment of the present invention, the physical object can be a card, a button, a block, and a figurine, and is configured to be moved around on or near the interactive surface.

In accordance with one embodiment of the present invention, the interaction with the physical object can be placing the physical object on or near the interactive surface, taking the physical object away from the interactive surface, or changing the physical object's location on the interactive board.

In accordance with one embodiment of the present invention, the interaction with the physical object can be touching the element of the user interface marked on the physical object, applying pressure to the element of the user interface marked on the physical object, or touching the element of the user interface marked on the physical object with a physical stylus.

In accordance with one embodiment of the present invention, the interaction with the physical object can be placing a first physical object on top of a second physical object, placing a first physical object next to a second physical object, or moving a first object away from a second object.

In accordance with one embodiment of the present invention, the system further includes a sensory accessory that is configured to produce an output in response to the interaction with the physical object. The sensory accessory can be an LED light, an audio device, a video device, a camera, or a vibration generator device.

### BRIEF DESCRIPTION OF THE DRAWINGS

FIG. 1 is an exemplary schematic diagram of an interactive surface with cards with printed elements placed on top of the interactive surface in accordance with an embodiment of the invention.

FIG. 2 is an exemplary schematic diagram of an interactive surface with both a sheet and cards with printed elements being placed on top of the interactive surface in accordance with another embodiment of the invention.

FIG. 3 is an exemplary schematic diagram of an interactive surface with a sheet with printed elements placed on top of the interactive surface in accordance with yet another embodiment of the invention.

FIG. 4 is an exemplary flowchart for a method for operating a computer program with physical objects in accordance with an embodiment of the present invention.

FIG. 5 is an exemplary flowchart for a method for operating a computer program with physical objects in accordance with another embodiment of the present invention.

### DETAILED DESCRIPTION OF THE INVENTION

Reference will now be made in detail to various embodiments of the invention illustrated in the accompanying drawings. While the invention will be described in conjunction with the embodiments, it will be understood that this is not intended to limit the scope of the invention to these specific embodiments. The invention is intended to cover all alternatives, modifications and equivalents within the spirit and scope of invention, which is defined by the apprehended claims. Furthermore, in the detailed description of the present invention, specific details are set forth in order to provide a thorough understanding of the present invention. However, it will be obvious to one of ordinary skill in the art that the present invention may be practiced without these specific details. In other instances, well known methods, procedures, components, and circuits are not described in details to avoid unnecessarily obscuring a clear understanding of the present invention.

For example, although the notion of an “interactive surface” is repeatedly used throughout this specification, it is understood that this is not intended to be a restriction on the scope of the invention. In fact, the present invention is easily applicable to a 3D surface whereby users interact with the interactive surface at different angles. Nevertheless, for the sake of simplicity, the embodiments of the present invention will be described in connection with a simple 2D surface design.

In addition, although in one embodiment of the present invention, the interactive surface makes use of pressure-sensitive sensors spread out using a simple array design, it is understood that other sensor technologies and array designs are also within the scope of this invention. For example, other sensor technologies such as capacitive switches, optical diodes, touch sensors, electric resistors and the like are all viable options and can be used in connection with embodiments of this invention.

The present invention may be better understood and its numerous objects and advantages will become apparent to those skilled in the art by reference to the accompanying drawings.

The embodiments of the present invention disclose a system and method for operating a computer program by placing physical objects, typically a sheet, with printed elements on top of an interactive surface and thereafter interacting with the printed material in order to operate the program.

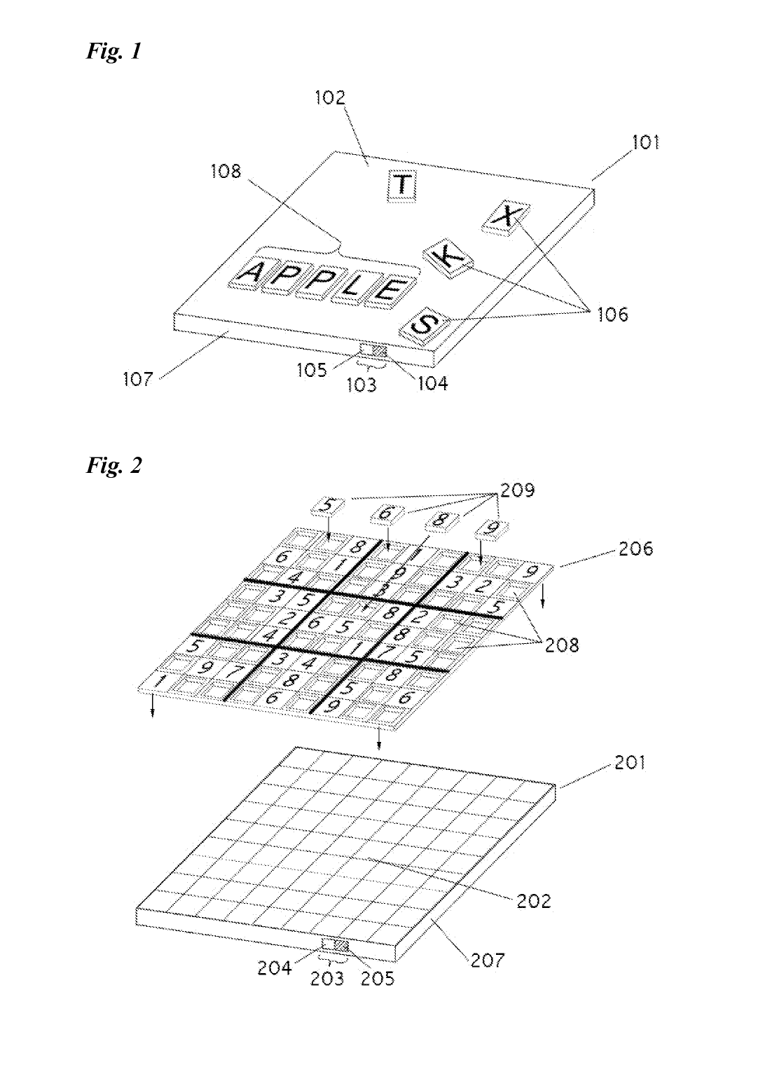

FIG. 1 is an exemplary schematic diagram of an interactive surface with cards with printed elements placed on top of the interactive surface in accordance with an embodiment of the invention.

For the sake of illustration, both the system and method described in FIG. 1 are designed specifically for an English educational spelling game but any person skilled in the art will recognize that this embodiment can have a large number of uses and designs.

FIG. 1 illustrates the interactive board 101 with an operating surface are 102 and a base unit 107. The operating surface area 102 consists of a sensor system that is capable of detecting the presence, identity and orientation of one or more cards set upon it. The sensor system of the operating surface 102 is electronically connected to a computer system 103 comprising both a CPU 104 and a memory unit 105. In this illustration, a number of cards 106, each with a letter of the alphabet printed on them, have been placed on top of the operating surface area 102 of the interactive surface 101.

The general method of the present embodiment is the following. Each time a card is placed on the interactive board 101, the computer system 103, via the sensor(s) of the operating surface area 102, detects the card's 106 location, unique ID and orientation. The computer system 103 then processes the data and determines what type of action/output to feedback according to a user defined program. Output could consist of but is not limited to physical feedback in the form of audio or visual effects.

FIG. 1 further illustrates how the system in accordance with this embodiment could be used in an educational spelling game. The computer program used in this embodiment is configured, once a card 106 has been detected and its ID determined, to firstly determine what letter of the alphabet the card corresponds to; when multiple cards 106 have been placed adjacent to one another to possibly create a word, the computer program is also configured to determine whether the string of letters consists of a real word. The processor determines this by firstly scanning for any strings of letters on the board and in the case strings of two or more letters are found, the processor proceeds to search the memory unit's 105 word database (or other databases that may or may not be linked directly to the computer system 103) for a matching string. If a match is found from the database then the computer program is configured to send out some sort of positive sensorial feedback to the user.

Referring back to FIG. 1, one can notice that there are several cards 108 that have been placed neatly on top of the operating surface area 102 in a line in order to create the word ‘Apple’. Since the 5 cards have been laid out on the operating surface area 102 in close enough proximately from each other, the computer system 103 recognizes these as being a string of words. The computer program then scans in its word database for a matching string of letters and the word ‘apple’ is found. Thus, the computer program has determined that the string of letters created is indeed a word and it will then command the computer system 103 to provide feedback to the user. Preferably the feedback would be in a form of audio where the word is read back to the user.

In this embodiment of the invention, the system comprises of a plurality of cards with printed elements that are placed upon an interactive surface. The interactive surface in this particular embodiment consisting of a base unit, a computer system (having at least both a processing and memory unit), an audio system, and an operating surface with a sensor array capable of detecting the location and ID of cards placed on top of the interactive surface. The cards printed elements consisting of a letter of the alphabet with each card having one letter only.

The method of the present embodiment is the following. Each time a card is placed on the board, the computer system, via the sensor(s) of the operating surface area, detects the card's location as well as its unique ID and orientation. According to this embodiment, the computer program is configured to detect any string (i.e., two or more) of cards whose printed letters constitute a word. More specifically, whenever two or more cards are placed in close proximity to each other (and preferably adjacent to each other), the computer system will first detect what was the string of letters that has just been made by the user and the computer program will then search a word database (i.e., consisting of a e-dictionary) that matches that string. If no match is found then no feedback is provided to the user. In the case that a word matches the string of letters depicted on the cards placed adjacent to each other, then the computer system will indicate to the user that they have spelt out a word. The computer system could indicate this to the user through any means but preferably through an audio output (reading out the word) and/or through visual effects such as lighting up LED lights on the interactive board.

FIG. 2 is an exemplary schematic diagram of an interactive surface with both a sheet and cards with printed elements being placed on top of the interactive surface in accordance with another embodiment of the invention.

FIG. 2 illustrates another embodiment in which the system comprises the combination of an interactive surface 201, a sheet 206 and multiple cards 209. For the sake of illustration, both the system and method described in FIG. 2 make use of the renowned Japanese mathematics game Sudoku as the design of that game is particular well suited for this embodiment of the invention.

The general system of the embodiment described in FIG. 2 includes the interactive board 201 having an operating surface 202 and a base unit 207. As with the embodiments described in the previous figure, the operating surface area 202 includes a sensor system capable of detecting the presence, identity and orientation of one or more cards placed upon it, and identifying the ID of the sheet 206 placed upon the operating surface area 202. Again, as with the previous embodiments, the sensor system of the operating surface area 202 is electronically connected to a computer system 203 comprising both a CPU 204 and a memory unit 205.

The embodiment in FIG. 2 further comprises of the sheet 206 with the typical 9*9 Sudoku grid printed upon it. As with all Sudoku games, some of the cases in the grid are already filled in with numbers and others are left blank. The holes 208 are made for those cases left blank in the grid. Cards 209, each with an Arabic numeral printed on them, comprise the last piece of this embodiment. These cards 209 are designed to be able to fit through the sheet's 206 holes 208 so that they are in direct contact with the interactive surface's 201 operating surface area 202.

The general method of the present embodiment is the following. The user places the sheet 206 on top of the interactive surface's 201 operating surface area 202. The computer system 203, via the sensor(s) of the operating surface area 202, detects the presence of the sheet 206 and identifies its ID. The orientation of the sheet is not important as the game can be played from any of the four sides of the interactive surface 201. Shortly after, the corresponding computer program for that particular Sudoku's grid is loaded by the computer system 203 and the user can proceed to solve the puzzle.

During the game, a user places various cards 209 through the holes 208 of the sheet 206 in order to solve the puzzle at hand. Whenever the user places a card 209 through the sheet 206 on the operating surface area 202, the computer system 203, via the sensor(s) of the operating surface area 202, detects the card's 209 location and unique ID. It then deduces from the card's 209 ID information the Arabic numeral that has been assigned to that card 209 and determines whether or not the card has been correctly placed relative to that particular Sudoku grid. There are a large number of ways one could design how the game will be played, but one design would be for the user to place cards 209 in all the sheet's 206 holes 208 before a timer runs out. A successfully or unsuccessfully completed puzzle can be indicated to the user through feedback from an audio and/or video device linked to the system.

This embodiment of the present invention involves a system and method that uses both a sheet with printed elements and cards with printed elements. The interactive surface in this system includes a base unit, a computer system (having at least a processing and memory unit), a sheet, one or more physical output devices (such as speakers or LED lights), and an operating surface with a sensor array capable of detecting the ID of both the sheet and the cards placed on top of the interactive surface. Furthermore, the sensor array is also capable of detecting the location of the cards placed on the operating surface. In this embodiment, the sheet has the starting grid of the Japanese mathematics game, Sudoku, printed on it. With some numbers printed in some boxes of the grid and empty boxes for those cases that are required by the user to fill in. The cards would each have an Arabic numeral printed on it.

The method of the present embodiment is the following. A sheet with the starting grid of the Sudoku game would be placed on top of the interactive surface. The sensors of the interactive surface would detect the presence of the sheet and send this information to the computer system. The computer system would then identify the sheet and load the corresponding computer program for that particular game of Sudoku.

Once the computer program has been loaded, it will be operated through an interaction with the physical objects. For instance, the user can then proceed to fill in the boxes of the sheet by placing various cards with Arabic numerals printed on them in order to solve the Sudoku puzzle. The sensors would detect any cards that are placed on the interactive surface and the computer system would then proceed to identify and locate the cards. Once the user has filled all the empty slots of the Sudoku grid, the computer program would then analyze whether this is the correct answer to the puzzle and the computer system would then inform the user through an audio message (or any other physical feedback medium such as LED lights) about the result.

In other embodiments of the present invention, the interaction with the physical object can also be taking the physical object away from the interactive surface, or changing the physical object's location on the interactive board.

In other embodiments of the present invention, the interaction with the physical object can be touching the element of the user interface marked on the physical object, applying pressure to the element of the user interface marked on the physical object, or touching the element of the user interface marked on the physical object with a physical stylus.

In other embodiments of the present invention, the interaction with the physical object can be placing a first physical object on top of a second physical object, placing a first physical object next to a second physical object, or moving a first object away from a second object.

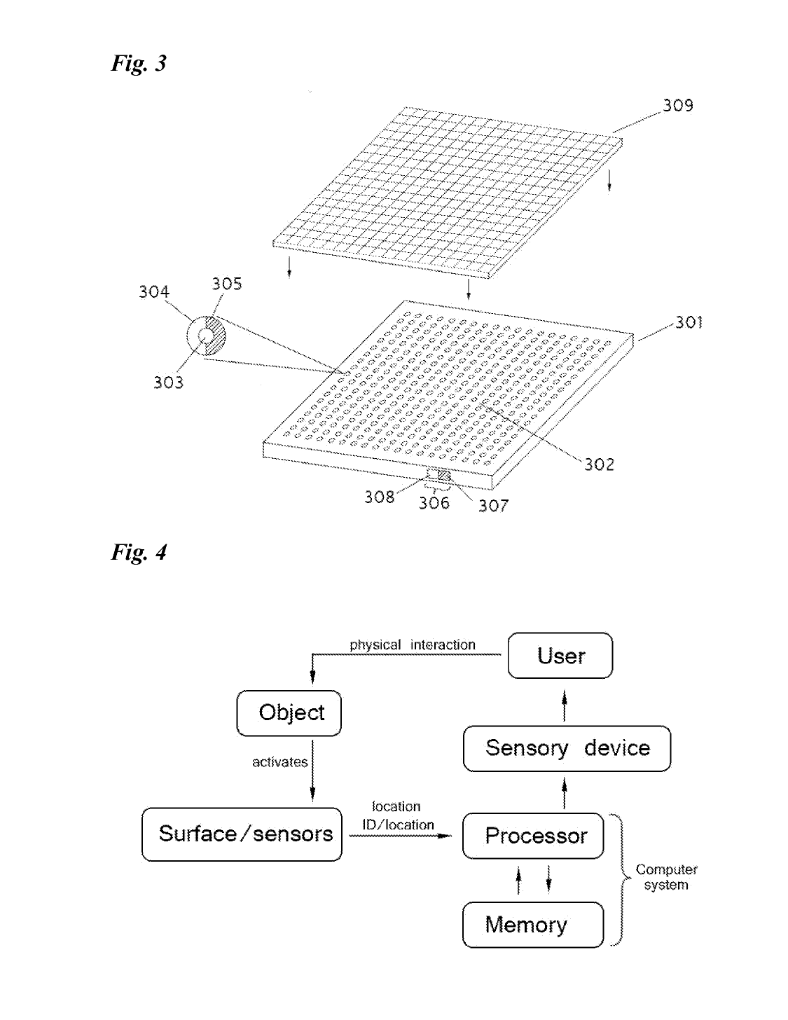

FIG. 3 is an exemplary schematic diagram of an interactive surface with a sheet with printed elements placed on top of the interactive surface in accordance with yet another embodiment of the invention.

FIG. 3 illustrates anther embodiment of the present invention making use of a sheet with printed material placed on top of the interactive surface. For the sake of illustration, both the system and method described in FIG. 3 are designed specifically to play the ancient Chinese board game of GO but any person skilled in the art will recognize that this embodiment has a large number of uses and designs.

As shown in FIG. 3, the interactive surface 301 comprises of an operating surface area 302 which is embedded with an array of pressure-sensitive sensors 303 arranged across 19 horizontal and vertical lines. LED lighting is affixed in close proximity of each sensor 303 of the array. For each sensor 303, the LED lights are configured to emit light of two substantially different colors 304, 305. Each box of the array is electrically connected to the interactive surface's 301 computer system 306 which comprises of CPU (Central Processing Unit) 307 and of a Memory Unit 108.

Once the interactive surface 301 has been activated, whenever a user presses (applies pressure) on one of the boxes of the array, the corresponding pressure sensitive sensor 303 is configured to inform the computer system 306 that it has been activated. The computer system is then configured to send back a signal to light up one of the two LED lights 304, 305 of the array intersection whose pressure sensitive sensor 303 has been activated. The computer system 306 is configured to switch back and forth between which LED colors 304, 305 to light up as the user activates different intersections of the array. If a LED color has lit up when the user has activated an intersection of the array, then the next-time the user (which is in effect the other player playing his/her turn) activates another array intersection, the other LED color is programmed to light up for that particular intersection.

FIG. 3 further illustrates the printed element design for the sheet 309 that is used as the user interface for this particular embodiment of the invention. In this case the printed element is simply a 19*19 grid array. People who are familiar with the ancient Chinese game of GO will recognize that this is the design for the GO game board.

The method of the game play for the system described in FIG. 3 is the following. Once the interactive surface 301 has been activated and the sheet 309 has been placed on top of the operating surface area 302, the computer system 306 loads up the corresponding computer program (i.e., the GO game program) from its memory unit 308. The users can then proceed to play the game. During the game, whenever a sensor 303 is activated by a user, a signal is sent to the computer system 306 containing information about which exact intersection on the GO board has been activated. The computer system 306 is then configured to send back a signal to light up one of the two LED lights 304, 305 that are affixed in close proximity of that sensor. The computer system 306 is configured to switch back and forth between which LED colors to light up as the user activates different intersections of the array. If a LED color has lit up when the user has activated an intersection of the array, then the next-time the user (which is in effect the other player now playing their turn) activates another intersection, the other LED color is programmed to light up.

As two players are playing each other on the embodiment described in FIG. 3, the game proceeds as a normal game of GO would be played but with the LED lights 304, 305 replacing the stones traditionally used in GO. The computer program is configured to use the rules of GO to survey the development of the game and provide feedback to users when needed. Typically feedback will be given to the users whenever a player makes an illegal move (the player will not be allowed to interact with the pressure-sensitive sensor if it infringes the rules) and to declare a winner instantly at the end of a game (the computer system would count which player has taken the most area of the interactive surface).

In this embodiment of the invention, the system comprises of a sheet that is placed upon an interactive surface. For example, the sheet's printed element being the grid of the renowned Chinese board game GO. The interactive surface in this embodiment includes of a base unit, a computer system (having at least both a processing and a memory unit), and an operating surface with a sensor array capable of detecting human touch at various locations across the interactive surface. The design of the array is made so that the 19*19 lines of the GO board game is mirrored on the interactive surfaces sensor array with each sensor representing one of the 361 intersection on the GO board. Furthermore, each sensor of the array having two LED lights of significantly different colors being affixed in close proximity to the sensor.

Once the interactive surface has been activated, whenever a sensor is activated by a user, a signal is sent to the computer system containing information about which exact intersection on the GO board has been activated. The computer system is then configured to send back a signal to light up one of the two LED lights that is affixed in close proximity of that sensor. The computer system is configured to switch back and forth between which LED colors to light up as the user activates different squares of the array. If a LED color has lit up when the user has activated an intersection of the array, then the next-time the user activates another intersection, the other LED color is programmed to light up.

Anybody familiar with the game of GO will instantly recognize the benefits of playing the game using this particular embodiment of the invention. For one, the interactive surface no longer requires the use of “stones” whereby players can track the progression of the game pieces (or “stones”) by simply looking at the pattern of LED lights across the board. One player's game pieces representing by the intersections of the board whose LED light of similar color have been lit up. Secondly, the computer system also allows for impartial refereeing and coaching. Players who are not yet familiar with the rules of GO are prompted by the interactive surface as to what moves they can or cannot make. Finally, once a game is finished the computer system can instantly declare a winner as opposed to a traditional GO game where players must count each of their game piece and then compare that number to their opponents.

FIG. 4 is an exemplary flowchart for a method for operating a computer program with physical objects in accordance with an embodiment of the present invention.

FIG. 4 illustrates the communication flow of the present invention, which helps to illustrate the core process of the present invention.

As shown in FIG. 4, a user 401 places an object 402 upon the interactive surface/sensors 403. This causes the interactive surface/sensors 403 to detect the presence of the object 402 on its operating surface area and send the data pertaining to the ID, location (or orientation) of the object 402 to the processor 404 to be processed. Depending on the data at hand, the processor 404 will seek out the command it needs to send out from the memory 405. Depending on the program, the processor 404 will then instruct a sensory device 406 to provide feedback to the user 401. This feedback may or may not prompt the user 401 to further interact with the object 402 which may restart the whole process described above.

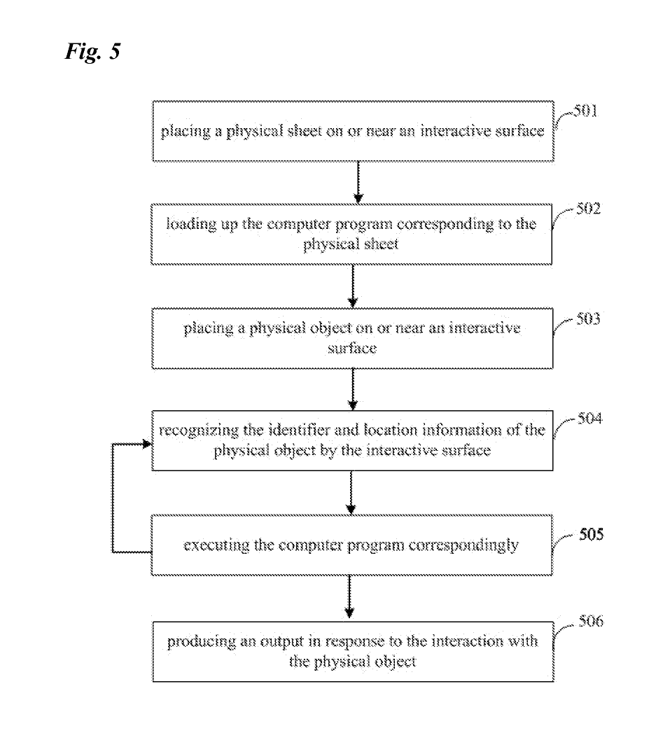

FIG. 5 is an exemplary flowchart for a method for operating a computer program with physical objects in accordance with another embodiment of the present invention. The method in this embodiment may be implemented in the system embodiment shown in FIG. 2.

As shown in FIG. 5, the method comprises the following steps.

Step 501: placing a physical sheet on or near an interactive surface without a display screen. For example, a sheet with the starting grid of the Sudoku game is placed on top of the interactive surface. And the sheet is configured to substantially cover the interactive surface.

Step 502: loading up the computer program corresponding to the physical sheet by a computer system operatively linked to the interactive surface. Once the sheet is placed on the interactive surface, the sensors of the interactive surface would detect the presence of the sheet and send this information to the computer system. The computer system would then identify the physical sheet and load the corresponding computer program for that particular game of Sudoku.

Step 503: placing a physical object on or near an interactive surface. Once the Sudoku program has been loaded, the user can then proceed to fill in the boxes of the sheet by placing a card with an Arabic numeral printed on to play the Sudoku puzzle.

Step 504: recognizing the identifier and location information of the physical object by the interactive surface. In this step, the sensors would detect the card placed on the interactive surface.

Step 505: executing the computer program corresponding to the physical sheet by the computer system. In this step, the computer system would proceed to identify and locate the card, and process accordingly. Step 504 and 505 can be repeated numerous times so that the user can use the cards to play the Sudoku game. The execution of the computer program is through an interaction with the physical object.

Step 506: producing an output in response to the interaction with the physical object. For example, once the user has filled all the empty slots of the Sudoku grid, the computer program would then analyze whether this is the correct answer to the puzzle, and if so, play an audio message “You are right” or a triumphant music piece.

1. A system for operating a computer program with physical objects, comprising:
an interactive surface without a display screen;
a computer system operatively linked to the interactive surface and configured to execute a plurality of computer programs;
a plurality of physical objects, wherein each physical object comprises an identifier and is marked with an element of a user interface of a computer program;
a physical sheet configured to substantially cover the interactive surface;
wherein, upon the physical sheet being placed on or near the interactive surface, the computer system is configured to load up the computer program corresponding to the physical sheet, and
wherein upon a physical object being placed on the physical sheet, the interactive surface is configured to recognize the identifier and location information of the physical object, the computer system is configured to execute the computer program corresponding to the physical sheet, and the computer program is configured to be operated through an interaction with the physical object.

2. The system of claim 1, wherein the identifier of the physical object comprises of a UID embedded in the physical object, and the interactive surface is configured to recognize the UID.

3. The system of claim 2, wherein the UID comprises an RFID chip.

4. The system of claim 1, wherein a physical object is selected from a group consisting of cards, buttons, blocks, and figurines, and is configured to be moved around on or near the interactive surface.

5. The system of claim 1, wherein the interaction with the physical object is selected from a group consisting of placing the physical object on or near the interactive surface, taking the physical object away from the interactive surface, and changing the physical object's location on the interactive board.

6. The system of claim 1, wherein the interaction with the physical object is selected from a group consisting of touching the element of the user interface marked on the physical object, applying pressure to the element of the user interface marked on the physical object, and touching the element of the user interface marked on the physical object with a physical stylus.

7. The system of claim 1, wherein the interaction with the physical object is selected from a group consisting of placing a first physical object on top of a second physical object, placing a first physical object next to a second physical object, and moving a first object away from a second object.

8. The system of claim 1, further comprising of a sensory accessory selected from a group consisting of an LED light, an audio device, a video device, a camera and a vibration generator device, wherein the sensory accessory is configured to produce an output in response to the interaction with the physical object.

9. A method for operating a computer program with a plurality of physical objects, comprising:
placing a physical sheet on an interactive surface without a display screen and substantially covering the interactive surface;
loading up a computer program corresponding to the physical sheet by a computer system;
placing a plurality of physical objects on the physical sheet, wherein each physical object comprises an identifier and is marked with an element of a user interface of the computer program corresponding to the physical sheet;
recognizing the identifier and location information of the physical object by the interactive surface;
executing the computer program corresponding to the physical sheet by a computer system operatively linked to the interactive surface; and
operating the computer program through an interaction with the physical object.

10. The method of claim 9, wherein the identifier of the physical object comprises of a UID embedded in the physical object, and the interactive surface is configured to recognize the UID.

11. The method of claim 10, wherein the UID comprises an RFID chip.

12. The method of claim 9, wherein the physical object is selected from a group consisting of cards, buttons, blocks, and figurines, and is configured to be moved around on or near the interactive surface.

13. The method of claim 9, wherein the interaction with the physical object is selected from a group consisting of placing the physical object on or near the interactive surface, taking the physical object away from the interactive surface, and changing the physical object's location on the interactive board.

14. The method of claim 9, wherein the interaction with the physical object is selected from a group consisting of touching the element of the user interface marked on the physical object, applying pressure to the element of the user interface marked on the physical object, and touching the element of the user interface marked on the physical object with a physical stylus.

15. The method of claim 9, wherein the interaction with the physical object is selected from a group consisting of placing a first physical object on top of a second physical object, placing a first physical object next to a second physical object, and moving a first object away from a second object.

16. The method of claim 9, further comprising producing an output in response to the interaction with the physical object through a sensory accessory selected from a group consisting of an LED light, an audio device, a video device, a camera and a vibration generator device.
